(19) United States
(12) Patent Application Publication
(10) Pub. No.: US 2019/0005759 A1
(43) Pub. Date: Jan. 3, 2019

(54) SYSTEMS AND METHODS FOR STORING, MANAGING, AND DISPENSING ITEMS AND GOODS FROM MULTI USER KIOSK

(71) Applicants: Timothy Island, San Diego, CA (US); James William Edwards, San Diego, CA (US)

(72) Inventors: Timothy Island, San Diego, CA (US); James William Edwards, San Diego, CA (US)

(21) Appl. No.: 16/015,216

(22) Filed: Jun. 22, 2018

Related U.S. Application Data
(60) Provisional application No. 62/523,776, filed on Jun. 23, 2017.

(51) Int. Cl. G07F 9/02; G07F 9/00; G06Q 20/18; G06Q 20/32

(52) U.S. Cl. CPC G07F 9/023; G06Q 20/327; G06Q 20/18; G07F 9/006

(57) ABSTRACT

Systems and methods for a multi-user, vandal-resistant digital kiosk to: (i) securely store a plurality of items and goods; (ii) authenticate dispensing a plurality of selectable and identifiable items and goods through mobile applications and/or kiosk interface, permit selection of items, communicate selection to authentication service, perform user verification including, but not limited to, government identification databases; biometric authentication to confirm user's identity and determine eligibility and enable interaction with the kiosk; (iii) enable system to receive user's payment; (iv) transmit purchase data to a remote database connected to multiple user interfaces; instructions to simultaneously dispense selected items and goods to multiple users at multiple kiosk exit portals; (v) enable modules to release only selected items and goods from inventory; (vi) enable multi-pass assembler to package only purchased items and goods by each user in chunks that fit the kiosk exit portals; (viii) enable inventory management through an offsite database using unique item identifiers; instruction to restock dispensed items and goods; (ix) store/track transaction data.

### BACKGROUND OF THE INVENTION

### Technical Field

This invention comprises software-hardware implemented methods of multiple synchronized interfaces which include: separate physical hardware components and component functions that allow storage, refrigeration, management and dispensing of a plurality of items and goods; and separate data processing systems subscribed to a central data storage system that receive data from mobile applications or embedded user interface display with user-identifying input mechanism based on user actuation and authentication. Based on these methods, a hardware-software implemented structure of the universal interface is proposed—the Multi-Interface Smart Machine (MISM), also referred to as the Multi-faced Automated Dispensary Kiosk.

### Description of Related Art

Many different types of automated kiosks, including the Automated Teller Machine, and automated vending machines have been developed for storing and dispensing inventory of items and goods. As technology and consumer behavior increasingly change, the traditional retail industry has been disrupted by ecommerce. The community of consumers is now connected through, among other things, smartphones and the Internet of Things (IoT). In this context, consumers want a seamless, frictionless, efficient and convenient shopping experience. Most kiosks and vending machines have been described or shown or made for slower consumer traffic and for processing one single transaction at a time. With its stand-alone eight-sided design, the proposed MISM is made, and utilizes the IoT, to deliver a secure and enhanced shopping experience, simultaneously, to multiple—four (4)—customers. The proposed MISM also collects, analyzes and uses customer data to target marketing and advertising, provide payment solutions, and trace and track each transaction. None of the automated machines in market can service 4 users at once. None of the traditional or automated kiosks and vending machines in the market show the MISM's unique octagon shape and design or is made to deliver consumers the integrated, fast and pleasant solution delivered by the MISM.

### SUMMARY OF INVENTION

The MISM is an interactive, automated, smart machine that, in ±1 minutes or less, allows the selection, sale, packaging, and dispensing of a plurality of items and goods, issues digital or paper sale receipts and, if necessary, dispenses cash to individual consumers. After the user inserts a readable government issued identification card into the machine, the MISM authenticates the user via a Secure File Transfer Protocol. If verified, the user selects the desired product(s) through a user interface system (UIS), and inserts money or a payment card into the MISM's point-of-sale portal (POS). After the POS processes and accepts the user's payment the sale transaction is completed and the MISM will dispense the purchased items and goods. The MISM's vault structure, including its exterior and interior surfaces, is fire and vandal-resistant. The MISM's system architecture tracks and stores users and product Information in a central database. The MISM's exterior surface also has multiple advertisement screens and surface-mounted biometric systems including facial recognition, and security systems with cameras that connect to a remote monitoring station.

### BRIEF DESCRIPTION OF THE DRAWINGS

Several sample embodiments are described below that refer to the following drawings, with each description number referring to the corresponding numbered drawing.

FIG. 1 is a graphical illustration of the MISM's eight-sided (octagon) frame exterior structure profiling eight flat faces vault panels.

FIG. 2 is a graphical illustration of 4 User Interface Systems (UIS) set on the exterior of the MISM, which support one or more input devices such as a touch screen, physical keyboard, and output devices (not shown) for communicating with the MISM's Centralized Computer System, at all four user terminals.

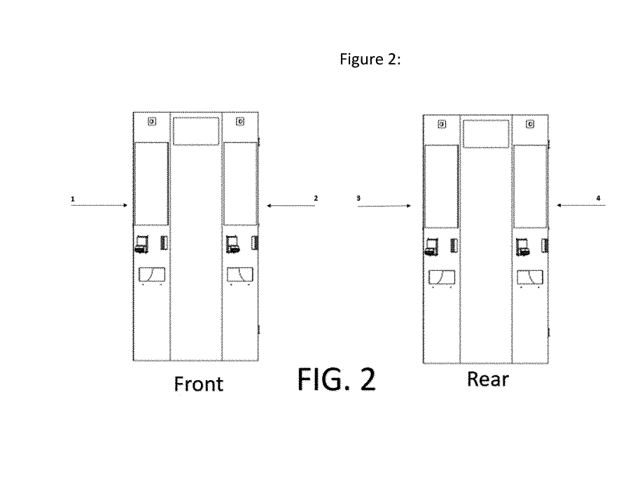

FIG. 3 is a graphical illustration of the Centralized Computer System (CCS) that regulates all physically connected peripherals and components of the MISM. The CCS initiates and deliver all applications, processes, and features of the MISM (access, dispensing, computing, storage, internet access, security, and inventory management).

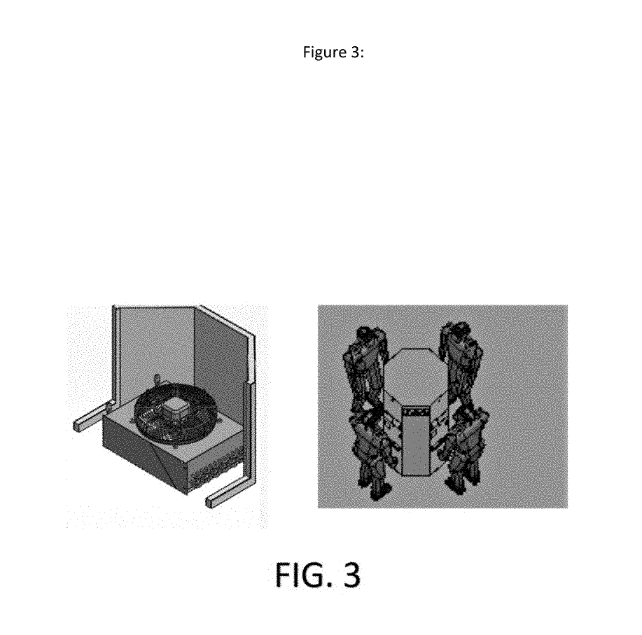

FIG. 4 is a graphical illustration of the 2 devices embedded in the structure of the MISM, which support 2 advertisement screens set on the exterior of the MISM.

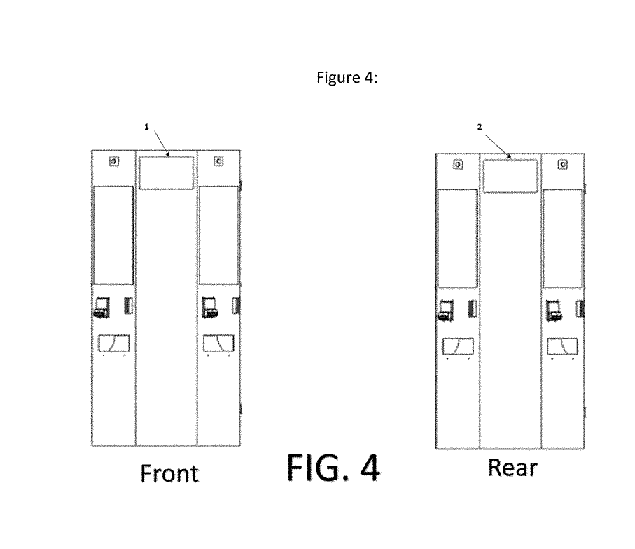

FIG. 5 is a graphical illustration of 4 Facial recognition/surveillance cameras mounted on the top of each UIS, at all four user terminals.

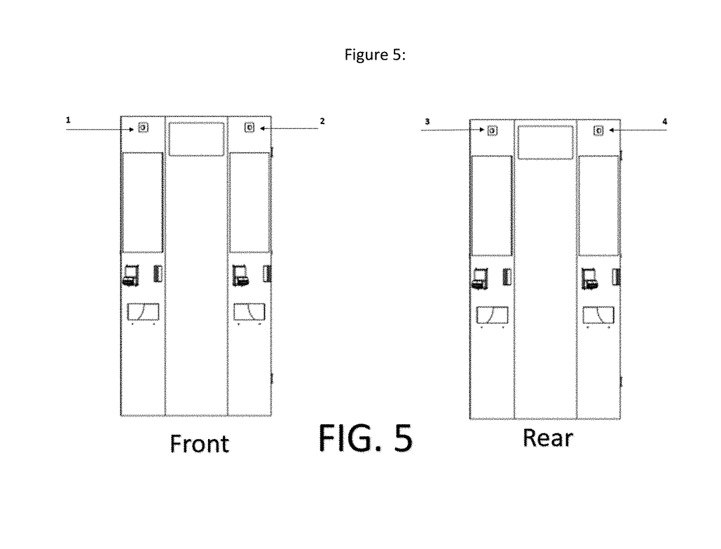

FIG. 6 is a graphical illustration of 4 point-of-sale portals with bill acceptor and change dispense, by which the MISM accepts and dispenses cash at all four user terminals.

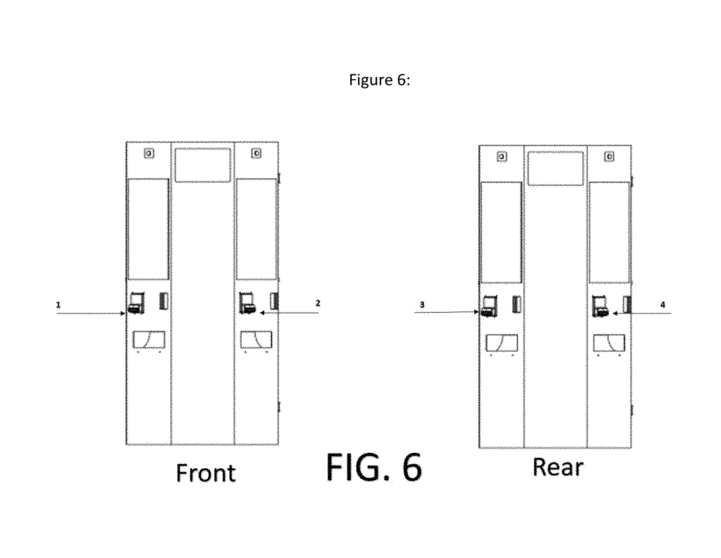

FIG. 7 is a graphical illustration of 4 user-identifying input devices that, based on user actuation, enables the CCS to receive data and activate user authentication at all four user terminals.

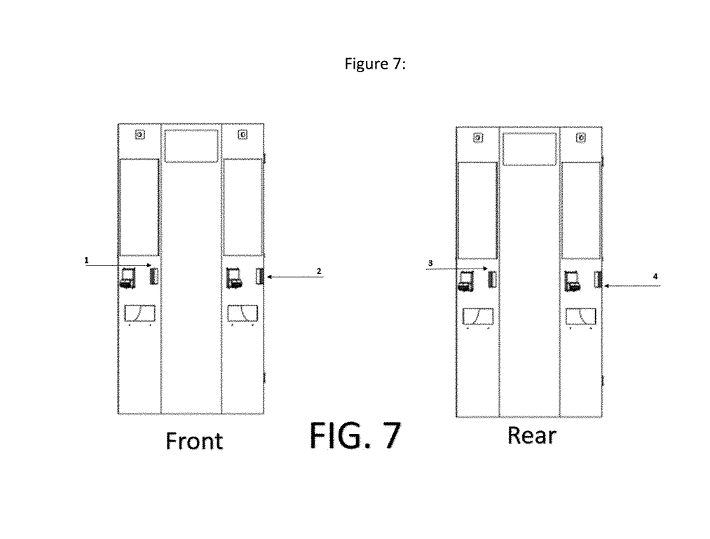

FIG. 8 is a graphical illustration of 4 devices that, based on user actuation, activate and process electronic payment via debit, pre-paid card or credit cards at all four user terminals.

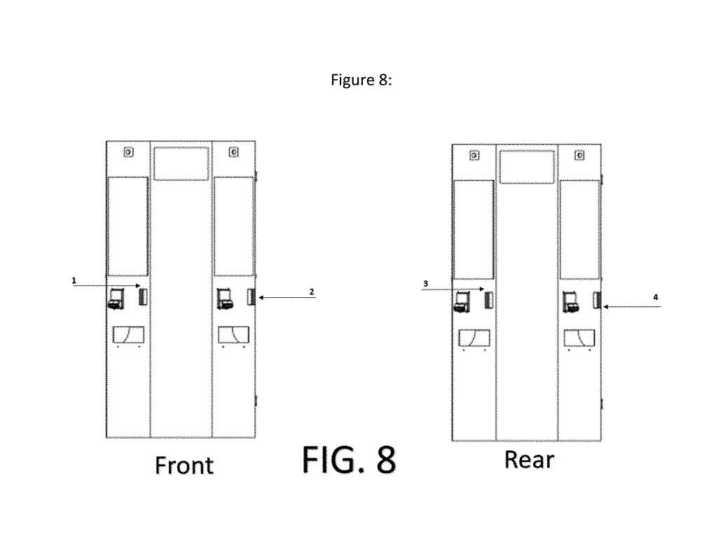

FIG. 9 is a graphical illustration of 4 exit portals by which the MISM dispenses a plurality of items and goods, at all four user terminals.

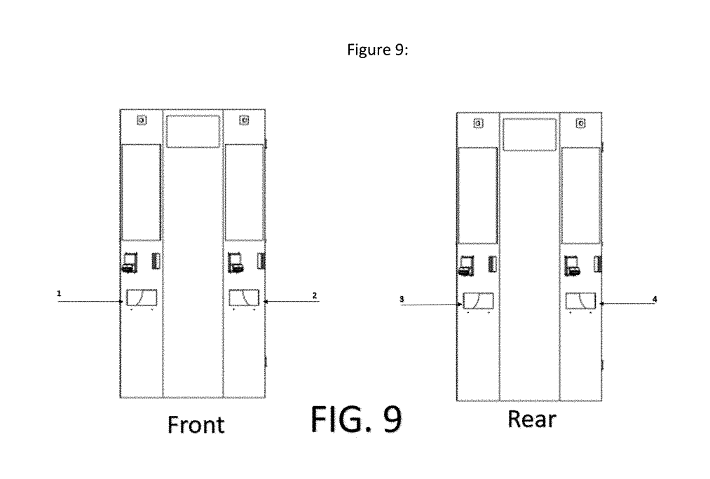

FIG. 10 is a graphical illustration of the universal structure of the MISM showing four users simultaneously purchasing and receiving selected items and goods dispense at the MISM's 4 exit portals.

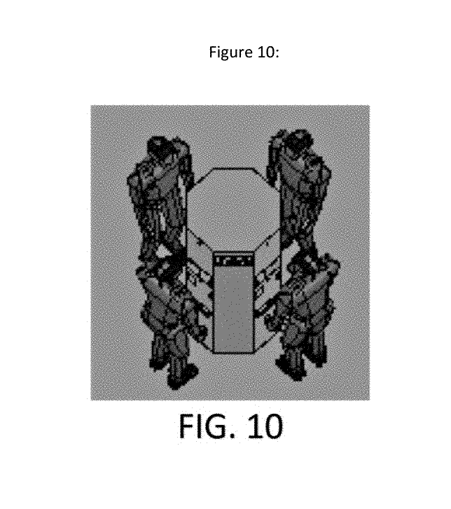

What is claimed:

1. A method implemented in part by a computer system and performed in part by hardware modules for simultaneously dispensing items/goods to four users on the same stand alone vending kiosk through multiple product exit portals.

2. A system allowing multiple commands subscribed to a centralized computer and a central data storage system linked to multiple separate user interfaces on the same vending unit that synchronizes receiving, processing, and sending data to enable 4 simultaneous sale transactions, and 4 simultaneous dispensing of selectable items/goods to 4 separate exit portals at 4 separate user terminals.

3. A method for instant touchless dispense that is executed by, but not limited to biometric scanning or mobile scanning via user interface.

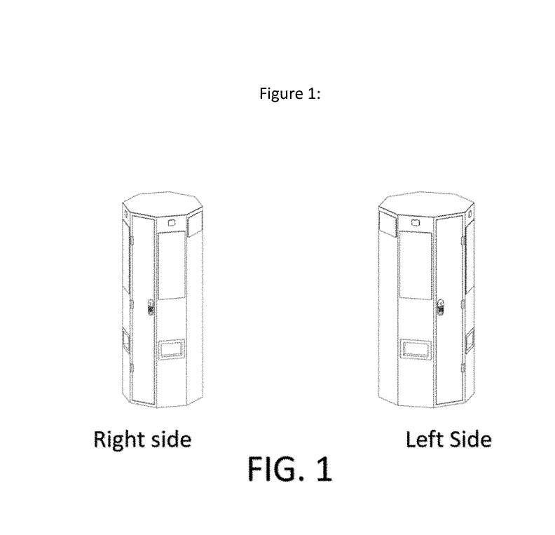

4. A method for a hardware universal frame with an octagonal prism structure as shown in FIG. 1.
a. A method for a hardware-software implemented integrated solution comprising a centralized computer, inventory storage and management modules, refrigeration, 4 touch screen user interfaces, 4 facial recognition/surveillance cameras, 4 bill acceptors/cash dispensers, 4 state ID/Driver's license readers, 4 debit/Credit card readers, 4 product portal pick up centers, and 2 advertisement screens for delivering a convenient, fast and fully integrated retail shopping experience.
